(19) United States
(12) Patent Application Publication
(10) Pub. No.: US 2008/0144064 A1
(43) Pub. Date: Jun. 19, 2008

(54) DEVICE FOR CONTROLLING POSITION-MARKING BY FINGER PRINT

(76) Inventor: Pi-Hui WANG, Hsinchu City (TW)

Correspondence Address: LEONG C LEI, PMB # 1008, 1867 YGNACIO VALLEY ROAD, WALNUT CREEK, CA, 94598, US

(21) Appl. No.: 11/553,484

(22) Filed: Oct. 27, 2006

(51) Int. Cl. G06K 15/00

(52) U.S. Cl. 358/1.12; 358/1.8

(57) ABSTRACT

A device for controlling position-marking by finger print is disclosed. The device comprises a housing having an image-accessing window on the surface thereof used as a sensing area, an IC control and a finger print sensor at the corresponding position of the imaging-accessing window for obtaining finger print pixel of the sensing area, characterized in that in combination with the IC control, the finger print sensor obtains continuous pixels of the finger prints of the user at a low resolution in the course of displacement of the finger prints at the sensing area for position marking.

### BACKGROUND OF THE INVENTION

(a) Technical Field of the Invention

The present invention relates to a device for controlling position-marking by finger print, and in particular, to a device employing finger print recognition mechanism to control the position of the cursor on the monitor screen.

(b) Description of the Prior Art

Employing monitor screen as an interface control is now commonly found in computers, PDA, machine tools, door security lockers, toys, etc.

In the application as control interface on monitor display, conventional mouse is used to control cursor position. In wired or wireless mouse signal transmission, the mouse has to be placed on a flat surface made of non-transparent material so as to provide normal cursor positioning function. In order to enhance security control, finger print which may not be faked easily is used to be recognized, and the currently available finger print recognition device provide only one function as finger print recognition.

### SUMMARY OF THE INVENTION

The primary purpose of the present invention is to provide a device for controlling position-marking by finger print comprising a housing having an image-accessing window on the surface thereof used as a sensing area, an IC control and a finger print sensor at the corresponding position of the imaging-accessing window for obtaining finger print pixel of the sensing area, characterized in that in combination with the IC control, the finger print sensor obtains continuous pixels of the finger prints of the user at a low resolution in the course of displacement of the finger prints at the sensing area for position marking.

Yet another object of the present invention is to provide a device for controlling position-marking by finger print, wherein the finger print sensor includes optical CCD, CMOS sensor or capacitance type sensor, and the image-accessing window is further provided with a cover either slidably mounted or securedly fastened.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example

### BRIEF DESCRIPTION OF THE DRAWINGS

FIG. 1 is a working flowchart showing of the device for controlling position-marking by finger print of the present invention.

FIG. 2 is a schematic sectional view showing the device in accordance with the present invention.

FIG. 3 is a working flow chart for recognition of finger prints for security control in accordance with the present invention.

FIG. 4 is a schematic sectional view of the device employing the capacitance type sensor of the present invention.

FIG. 5 is a schematic sectional view showing a securedly fastened cover at the image-accessing window at the housing in accordance with the present invention.

FIG. 6 is a sectional schematic view showing a slidably mounted cover at the image-accessing window at the housing in accordance with the present invention.

FIG. 7 schematically shows an actual application of the device according to the present invention.

FIG. 8 schematically shown a further actual application of the device according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

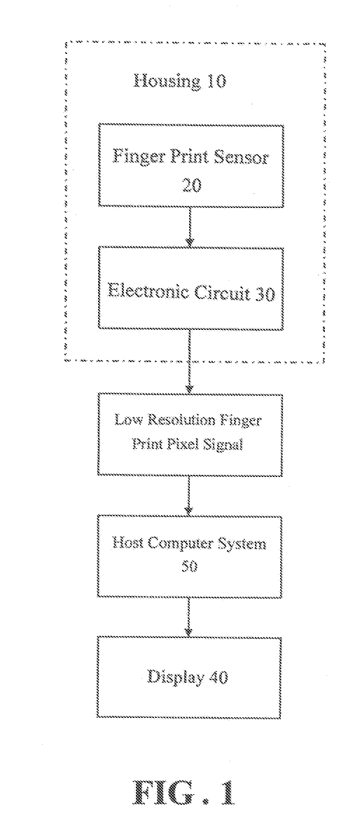

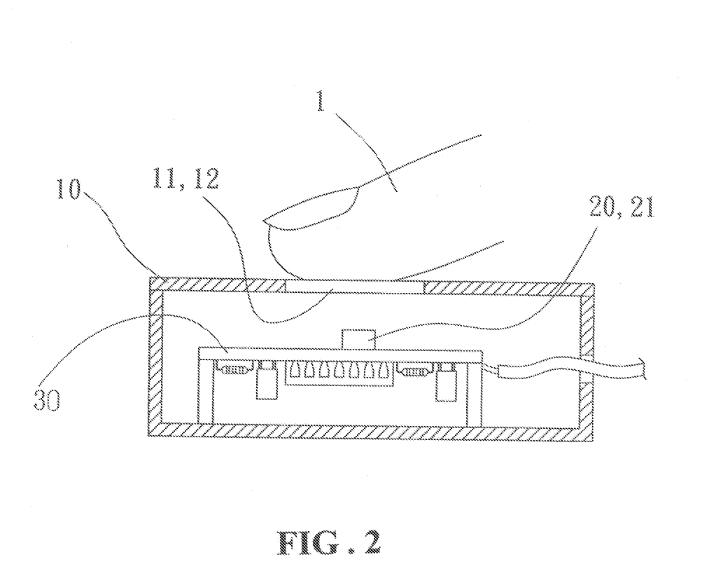

Referring to FIGS. 1 and 2, there is shown a device for controlling position-marking by finger print. The device is used as interface control for monitor display 40 connected to a host computer system 50, such that the position making of the cursor 41 on the monitor display 40 can be controlled. The device of the present invention comprises a housing 10 having an image-accessing window 11 at an appropriate position on the surface of the housing 10 as the finger print sensing area 12 for finger 1. A finger print sensor 20 is mounted at a position corresponding to the window 11 for the obtaining of finger print pixel of the sensing area 12.

In accordance with the present invention when the user places one of his fingers 1 with the finger print area onto the sensing area 12 of the housing 10, in combination with an electronic circuit 30 operation, the finger print sensor 20 can obtain a great amount of continuous finger print pixel when the finger print displacement on the sensing area 12 at a low resolution. Based on the analysis on the variation relationship of the continuous pixels, the displacement vector and rate of the finger print can be analyzed, thus, the host computer system 50 controls the relative displacement of the cursor on the monitor display 40.

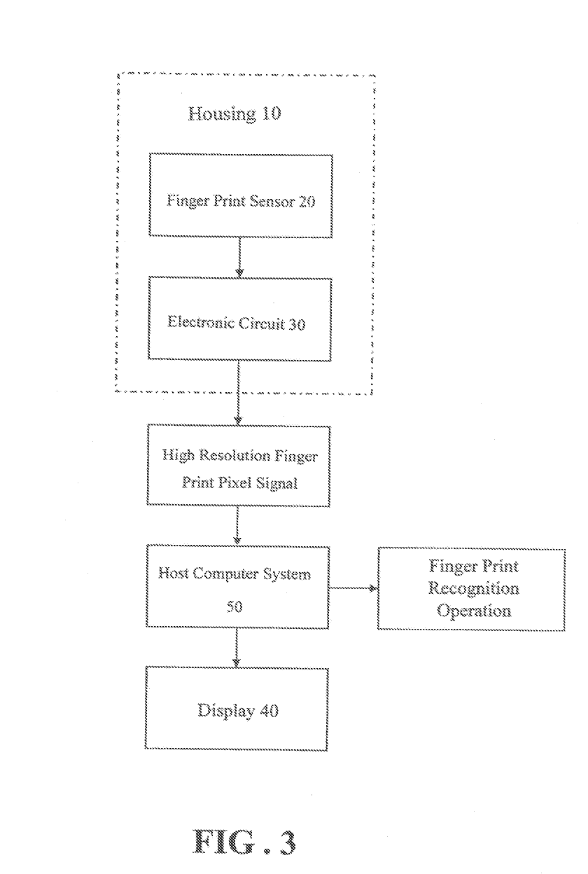

Referring again to FIGS. 2 and 3, there is shown another feature of the present invention. When the user places one of his fingers 1 with the finger print area onto the sensing area 12 of the housing 10, in combination with an electronic circuit 30 operation, the finger print sensor 20 can obtain finger print pixel at the sensing area 12 with high resolution.

The finger print pixels are transmitted to the monitor display 40 of the linked host computer system 50 for finger print recognition operations such as storage, analysis and comparison.

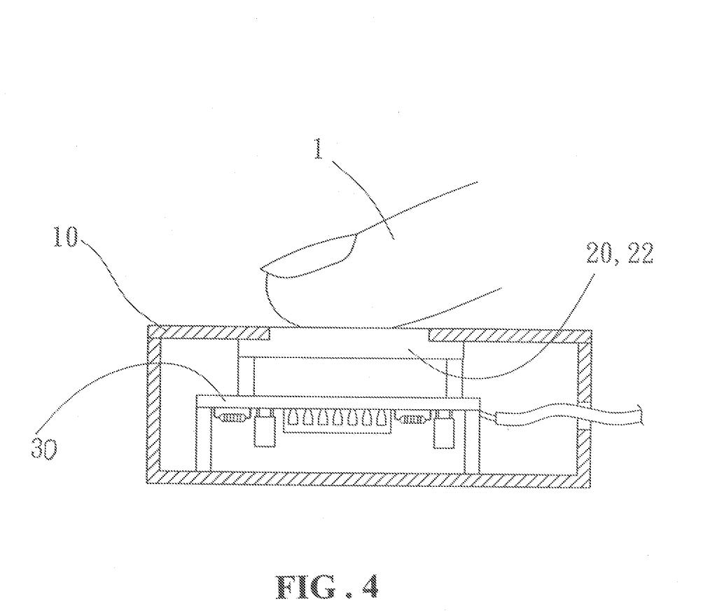

Thus the device provides finger print recognition for security control. In view of the described device, the finger print sensor 20 can be optical CCD or CMOS sensor 21, or a common capacitance sensor 22 as shown in FIG. 4.

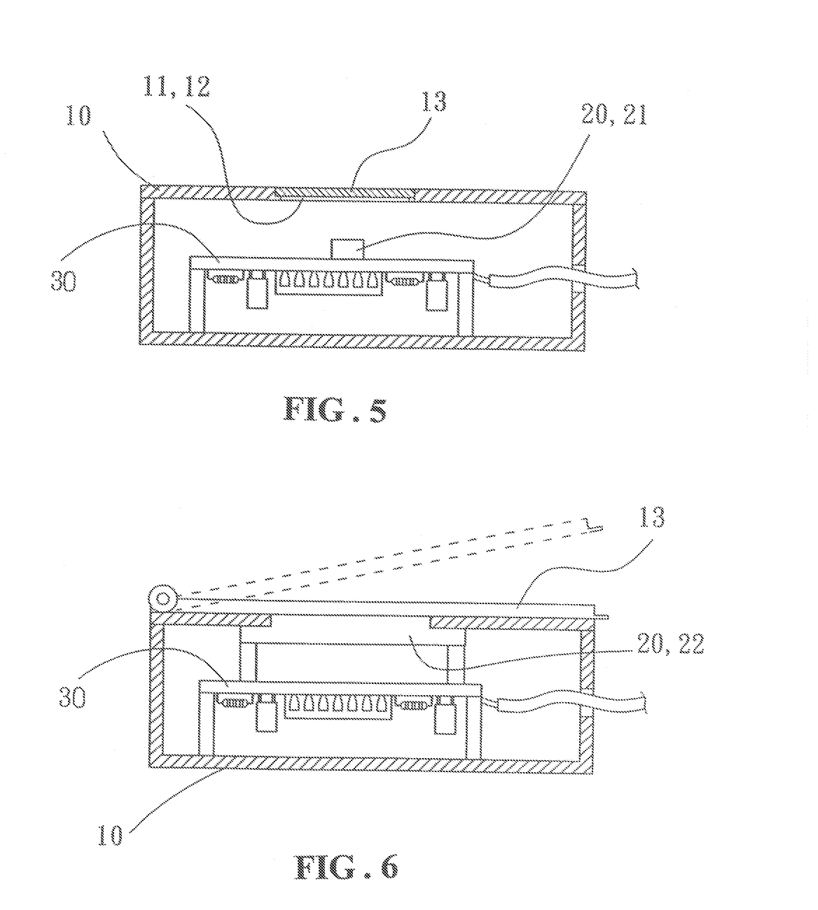

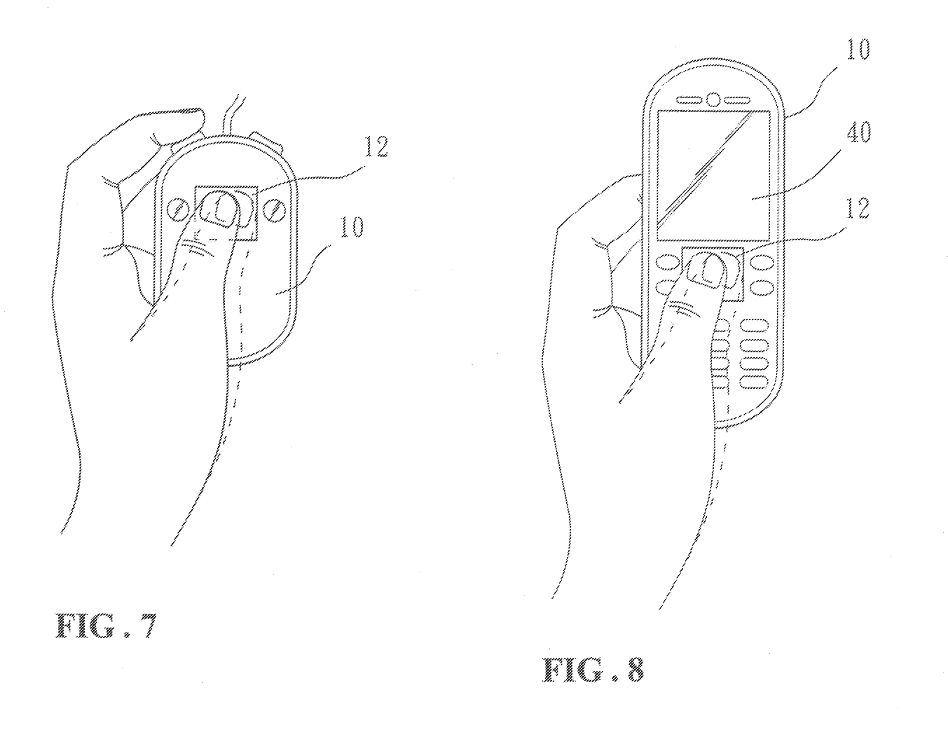

FIG. 5 shows the device of the present invention of another preferred embodiment has a housing 10. The housing 10 includes a cover 13 mounted correspondingly to the sensing area 12 so as to avoid the touching of the sensing surface of the finger print sensor 20. When the finger print sensor is optical CCD or CMOS sensor 21, the cover 13 is made of transparent material, facilitating the sensing area 12 to take images of the finger print. When the finger print sensor 20 is capacitance type sensor 22 the cover 13 can either be made from a transparent or a non-transparent material. Further, the cover 13 can be securedly fastened and can also be slidably mounted as shown in FIG. 6.

In the above preferred embodiment, the actual configuration of the housing 10 includes hand-held or fitted housing 10. Further, the housing can be the type of housing of the host computer system 50 which links with a monitor display 40.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device for controlling position-marking by finger print comprising a housing having an image-accessing window on the surface thereof used as a sensing area, an IC control and a finger print sensor at the corresponding position of the imaging-accessing window for obtaining finger print pixel of the sensing area, characterized in that in combination with the IC control, the finger print sensor obtains continuous pixels of the finger prints of the user at a low resolution in the course of displacement of the finger prints at the sensing area for position marking.

2. The device as claimed in claim 1, wherein the finger print sensor obtains continuous pixels of the finger prints of the user at a higher resolution in the course of displacement of the finger prints at the sensing area for position marking.

3. The device as claimed in claim 1, wherein the finger print sensor includes optical CCD, CMOS sensor or capacitance type sensor.

4. The device as claimed in claim 1, wherein the image-accessing window is further provided with a cover either slidably mounted or securedly fastened.

5. The device as claimed in claim 1, wherein the housing is portable or is securedly mounted.
